(19) United States
(12) Patent Application Publication
(10) Pub. No.: US 2007/0285376 A1
(43) Pub. Date: Dec. 13, 2007

(54) DATA DRIVER AND DRIVING METHOD OF TFT-LCD

(75) Inventor: Chi-Mao Hung, Chiayi City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: AU OPTRONICS CORP., Hsinchu (TW)

(21) Appl. No.: 11/531,345

(22) Filed: Sep. 13, 2006

(30) Foreign Application Priority Data
Jun. 8, 2006 (TW) 95120369

(51) Int. Cl. G09G 3/36

(52) U.S. Cl. 345/100

(57) ABSTRACT

A data driver for a TFT-LCD. N₁ channels of the data driver can be disabled. The data driver comprises a multiplexer and a shift register. The multiplexer receives a horizontal start pulse and at least one control signal. Output signals are transmitted from output terminals of the multiplexer according to the control signals. The shift register receives a clock signal and the output signals and generates a start pulse. The start pulse determines to provide a first image data at a first channel or a (N₁+1)th channel according to which output terminal the signal is output from.

### BACKGROUND OF THE INVENTION

1. Field of the Invention

The invention relates to a thin film transistor liquid crystal display (TFT-LCD) and, in particular, to a data driver thereof.

2. Description of the Related Art

FIG. 1A, shows a thin film transistor liquid crystal display (TFT-LCD) with a resolution of 800 RGB×480 requiring five data driver ICs. Because there are 800×3 channels in a horizontal direction of the screen, 5 data driver ICs provide exactly 480-channel output to all channels. To reduce cost, the number of data driver ICs may be reduced to 3 from 5. Thus, the number of channels of each data driver IC should be 800, which is not a multiple of 3. RGB, however, is regarded as an indivisible unit in data driver IC design, thus, 800 is not a feasible channel number and needs to be modified as 801 or 804 for use in data driver IC design. When symmetry is also taken into consideration, 840 are typically recommended.

When there are 804 channels in the data driver IC, existing timing controllers are not applicable. As shown in FIG. 1B, 12 channels in one of the data driver ICs are not used and thus are not applicable to bi-directional applications. In addition, the timing controllers must be modified. Additional first-in-first-out (FIFO) circuits are required to latch data and dump the data. FIG. 1C illustrates another case. In FIG. 1C, 6 channels on each end of the data driver IC are unused. Such a symmetrical layout is applicable to bi-directional applications. Existing timing controllers, however, cannot provide corresponding support.

### BRIEF SUMMARY OF THE INVENTION

Data drivers and driving methods for TFT-LCDs are provided. In an exemplary embodiment of a data driver for a TFT-LCD N₁ channels of the data driver can be disabled. The data driver comprises a multiplexer and a shift register. The multiplexer receives a horizontal start pulse and at least one control signal. Output signals are transmitted from output terminals of the data driver according to the control signals. The shift register receives a clock signal and the output signals and generates a start pulse. The start pulse determines to provide first image data at a first channel or a (N₁+1)th channel according to which output terminal the signal is output from.

An exemplary embodiment of a driving method for a thin film transistor liquid crystal display (TFT-LCD) comprises providing a plurality of control signals and determining whether to disable a predetermined number of output channels according to combinations of the control signals.

By use of the multiplexer and the shift register, a portion of channels of the data driver can be disabled via control signals such that flexibility in application of the data driver is improved.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a layout diagram of a conventional thin film transistor liquid crystal display (TFT-LCD);

FIGS. 1B and 1C are layout diagrams of a TFT-LCD according to an embodiment of the invention;

FIG. 2 is a schematic diagram of a channel disable select circuit of a data driver IC according to an embodiment of the invention;

FIG. 3 is a schematic diagram of a liquid crystal display (LCD) panel according to an embodiment of the invention;

FIG. 4 is a schematic diagram of a liquid crystal module (LCM) according to an embodiment of the invention; and

FIG. 5 shows a driving method of a thin film transistor liquid crystal display (TFT-LCD) according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Flexibility in application of data driver ICs is improved in that compatibility with existing timing controllers is increased, additional circuits are added to the data driver ICs for selective disablement of some output channels thereof, thus rendering the total number of output channels of the data driver ICs equivalent to a horizontal resolution of a screen. A thin film transistor liquid crystal display (TFT-LCD) comprising data driver ICs with 804 channels are provided as an example, however, the scope of the invention is not limited thereto.

To selectively disable some output channels of data driver ICs, a designer can implement the instructions listed in the following table.

TABLE I

| ENOS | OS1 | OS2 | Function description |
|---|---|---|---|
| 1 | X | X | No output channel is disabled. |
| 0 | 0 | 0 | 12 output channels on a left end of the data driver |
| | | | IC are disabled. |
| 0 | 0 | 1 | 12 output channels on a right end of the data |
| | | | driver IC are disabled. |
| 0 | 1 | 0 | 6 output channels on a left end of the data driver |
| | | | IC are disabled. |
| 0 | 1 | 1 | 6 output channels on a right end of the data driver |
| | | | IC are disabled. |

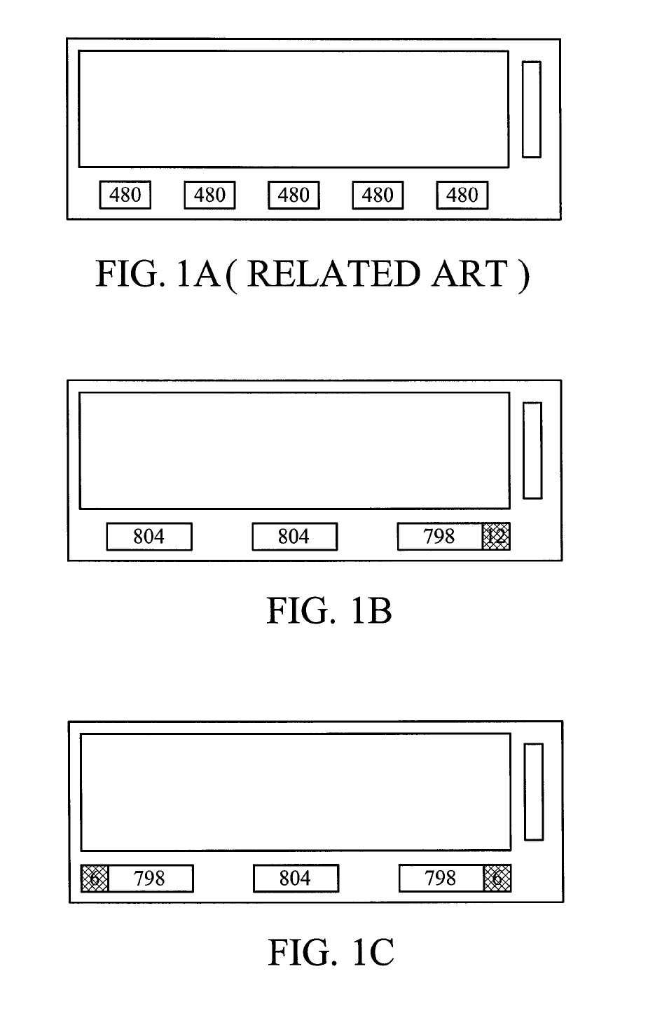

ENOS, OS1, and OS2 are control signals of the circuit added by the designer. Some output channels are selectively disabled via combinations of the control signals. Layouts of a display panel and the data driver ICs are respectively shown in FIGS. 1B and 1C.

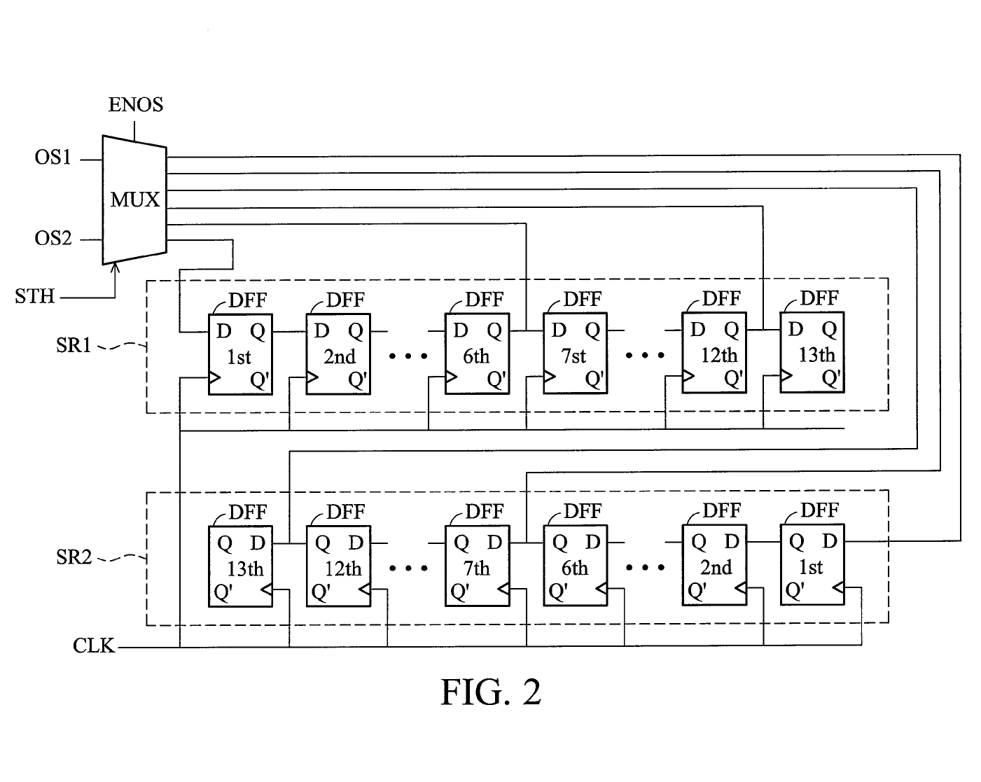

FIG. 2 is a schematic diagram of a channel disable select circuit of a data driver IC according to an embodiment of the invention. The channel disable select circuit comprises a multiplexer MUX, a first shift register SR1 and a second shift register SR2. The multiplexer MUX receives a horizontal start signal STH and control signals OS1, OS2 and ENOS. Output signals of the multiplexer MUX are determined according to combinations of the control signals OS1, OS2 and ENOS. The horizontal start signal STH comes from a timing controller (not shown in FIG. 2). A user inputs the control signals via pins of the data driver IC. The first shift register SR1 and the second shift register SR2 have opposite directions. The shift registers receive the same output signals from the multiplexer MUX and clock signal CLK and generate a start pulse. The start pulse determines which channel to output the first image data according to which output terminal the signal is output from.

In FIG. 2, the first shift register SR1 and the second shift register SR2 each comprise a plurality of D flip-flop (DFF). Each D flip-flop receives the clock signal CLK. A data input terminal D of the first D flip-flop is coupled to a first output terminal OUT1 of the multiplexer MUX. A data input terminal D of each of the subsequent D flip-flop is coupled to a data output terminal Q of a preceding D flip-flop. The data output terminal Q of the sixth D flip-flop of the first shift register SR1 is also coupled to a second output terminal OUT2 of the multiplexer MUX. As a result, with a properly designed multiplexer, the data driver IC outputs the first image data at the first channel thereof when the control signal ENOS is 1. When the control signals ENOS, OS1 and OS2 are respectively 0, 1, and 0, six channels on the left end of the data driver IC are disabled and the data driver IC outputs the first image data at the seventh channel on the left end thereof. As shown in FIG. 2, the data output terminal Q of the twelfth D flip-flop of the first shift register SR1 is also coupled to a third output terminal OUT 3 of the multiplexer MUX. Thus, with a properly designed multiplexer, twelve channels on the left end of the data driver IC are disabled and the same outputs the first image data at the thirteenth channel on the left end thereof when the control signals ENOS, OS1 and OS2 are all 0. In the disclosure, the first shift register SR1 is implemented with D flip-flops. The scope of the invention is, however, not limited thereto. RS flip-flops, T flip-flops, and JK flip-flops are also applicable to the first shift register SR1.

In FIG. 2, I/O directions of the second shift register SR2 are opposite to that of the first shift register SR1. The data output terminal Q of the sixth D flip-flop of the second shift register SR2 is also coupled to a fourth output terminal OUT4 of the multiplexer MUX. As a result, with a properly designed multiplexer, six channels of the right end of the data driver IC are disabled and the same outputs the first image data at the seventh channel on the right end thereof when the control signal ENOS, OS1 and OS2 are respectively 0, 1, and 1. As shown in FIG. 2, the data output terminal Q of the twelfth D flip-flop of the second shift register SR2 is also coupled to a first output terminal OUT1 of the multiplexer MUX. Thus, with a properly designed multiplexer, twelve channels on the right end of the data driver IC are disabled and the same outputs the first image data at the thirteenth channel on the right end thereof when the control signals ENOS, OS1 and OS2 are respectively 0, 0, and 1. In the disclosure, the first shift register SR2 is implemented with D flip-flops. However, scope of the invention is not limited thereto. RS flip-flops, T flip-flops, and JK flip-flops are also applicable to the second shift register SR2.

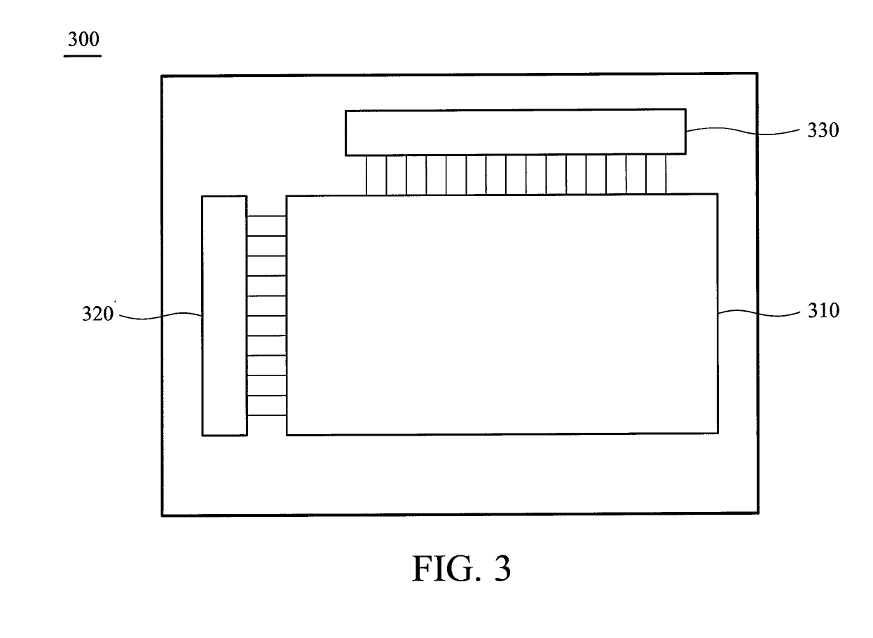

FIG. 3 is a schematic diagram of a liquid crystal display (LCD) panel 300 according to an embodiment of the invention. The LCD panel comprises a liquid crystal (LC) pixel array 310, a gate driver 320 and a disclosed data driver 330. The LC pixel array comprises a plurality of pixels arranged in array. Each pixel is driven by a pixel driving circuit. Each pixel driving circuit is coupled to the gate driver 320 and the data driver 330.

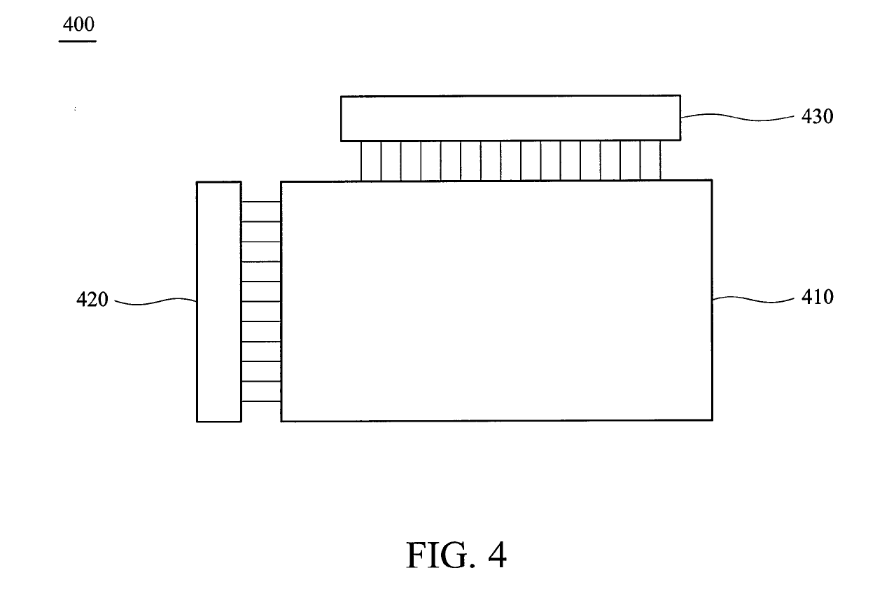

FIG. 4 is a schematic diagram of a liquid crystal module (LCM) 400 according to an embodiment of the invention. The LCM comprises a liquid crystal display (LCD) panel 410, a gate driver IC 420, and a disclosed data driver IC 430. The LC panel mainly comprises a LC pixel array comprising a plurality of pixels arranged in array. Each pixel is driven by a pixel driving circuit. Each pixel driving circuit is coupled to the gate driver IC 420 and the data driver IC 430.

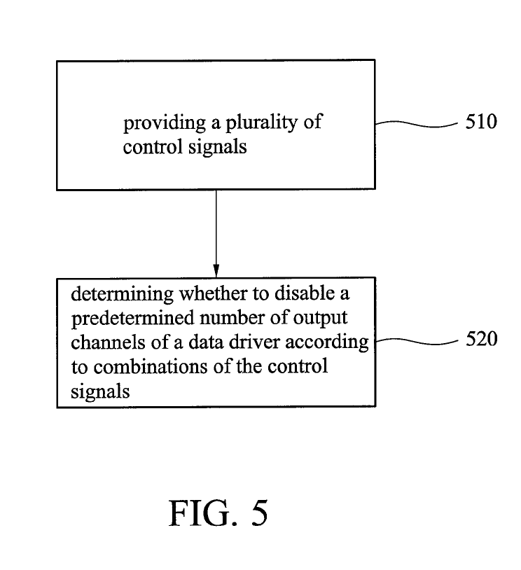

FIG. 5 shows a driving method of a thin film transistor liquid crystal display (TFT-LCD) according to an embodiment of the invention. The driving method comprises providing a plurality of control signals (step 510) and determining whether to disable a predetermined number of output channels of a data driver according to combinations of the control signals (step 520).

By use of the multiplexer and the shift register, a portion of channels of the data driver can be disabled via control signals such that flexibility in application of the data driver is improved.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A data driver for a thin film transistor liquid crystal display (TFT-LCD), with N1 channels thereof selectively disabled, comprising:
a multiplexer receiving a horizontal start pulse and at least one control signal, wherein output signals of the multiplexer are controlled by the control signals; and
a first shift register receiving a clock signal and the output signals and generating a start pulse;
wherein the start pulse determines to provide a first image data at a first channel or a (N₁+1)th channel according to which output terminal the signal is output from.

2. The data driver as claimed in claim 1, wherein the first shift register comprises a plurality of flip-flops receiving the clock signal, a data input terminal of the first flip-flop is coupled to a first output terminal of the multiplexer, a data input terminal of each of the subsequent flip-flops is coupled to a data output terminal of a preceding flip-flop, and a data output terminal of the N₁th flip-flop is coupled to a second output terminal of the multiplexer.

3. The data driver as claimed in claim 1, wherein the flip-flops comprise D flip-flops, RS flip-flops, T flip-flops, JK flip-flops and combinations thereof.

4. The data driver as claimed in claim 1, further capable of disabling N₂ output channels thereof, wherein a data output terminal of the N₂th flip-flop is coupled to the third output terminal of the multiplexer.

5. The data driver as claimed in claim 1, further capable of disabling N₃ output channels thereof, further comprising a second shift register receiving the clock signal and the output signals and generating the start pulse signal, wherein the first and second shift registers have opposite directions.

6. The data driver as claimed in claim 5, wherein the second shift register comprises a plurality of flip-flops.

7. The data driver as claimed in claim 6, wherein the flip-flops comprise D flip-flops, RS flip-flops, T flip-flops, JK flip-flops and combinations thereof.

8. A flat display module comprising the data driver as claimed in claim 1.

9. The flat display module as claimed in claim 8, wherein the flat display module comprises liquid crystal display.

10. A driving method of a thin film transistor liquid crystal display (TFT-LCD), comprising:
providing a plurality of control signals; and
determining whether to disable a predetermined number of output channels according to combinations of the control signals.
